(19) United States
(12) Patent Application Publication
(10) Pub. No.: US 2006/0158513 A1
(43) Pub. Date: Jul. 20, 2006

(54) Recognizing film and video occurring in parallel in television fields

(76) Inventors: Abraham Karel Riemens, Eindhoven (NL); Ardjan Dommisse, Eindhoven (NL); Gerard De Haan, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/537,887

(22) PCT Filed: Nov. 12, 2003
(86) PCT No.: PCT/IB03/05372

§ 371 Date: Jun. 7, 2005

(30) Foreign Application Priority Data
Dec. 12, 2002 (EP) 02080239.3

(51) Int. Cl. H04N 5/253; H04N 3/36; H04N 9/11; H04N 9/47

(52) U.S. Cl. 348/97

(57) ABSTRACT

A motion sequence pattern detector (300,301) for detecting presence of film material in a series of consecutive video fields (pp,p,c), is arranged to compute for a first one of the consecutive fields a value of a video motion measure and a value of a film motion measure and to determine the presence of film material on basis of both motion measures. The value of the video motion measure is computed by: establishing a plurality of motion patterns for respective groups of pixels of the first one of the consecutive fields; comparing each of the plurality of motion patterns with a predetermined video motion pattern and conditionally increasing the value of the video motion measure. The value of the film motion measure is computed by comparing each of the plurality of motion patterns with a predetermined film motion pattern and conditionally increasing the value of the film motion measure.

The invention relates to a motion sequence pattern detector for detecting presence of film material in a series of consecutive video fields.

The invention further relates to an image processing apparatus, comprising:

receiving means for receiving a signal corresponding to a series of consecutive video fields;

such a motion sequence pattern detector; and

an image processing unit for computing a sequence of output images on basis of the series of consecutive video fields, the image processing unit being controlled by the motion sequence pattern detector.

The invention further relates to a method of detecting presence of film material in a series of consecutive video fields.

The invention further relates to a computer program product to be loaded by a computer arrangement, comprising instructions to detect presence of film material in a series of consecutive video fields.

When focussing on picture rates, three formats can be distinguished:

50 Hz video: A transmission standard, commonly known as PAL or SECAM that comprises 50 interlaced fields per second. Each frame comprises 625 lines of which the even and odd lines are alternatingly transmitted as fields. The 50 Hz video standard is used in most countries throughout the world except Japan and North America.

60 Hz video: A transmission standard, commonly known as NTSC that comprises 60 (59.94 to be exact) interlaced fields per second. Each frame comprises 525 lines of which the even and odd lines are alternatingly transmitted as fields. The 60 Hz video standard is used in Japan and North America.

24 Hz film: Film corresponds to a method of recording moving images on a long strip of transparent material. The frame rate of 24 images per second is a compromise between the ability to capture motion and the amount of film required per time interval. The standard is older than the video transmission standards. Attempts were made to adapt the frame rate to 25 and 30 images per second, in order to become more compatible with transmission standards. Except for some exceptions, e.g. commercials, these frame rates did not find major much support in the motion picture industry. Therefore, 24 Hz film remains the most commonly used standard for motion pictures.

When television became a popular medium, the need for new content increased. This called for format conversion methods. Besides converting motion pictures to television, television shows were exchanged between different transmission standards. This content also needed conversion. Later, when the television was dominant, video material was converted to film, e.g. to show television commercials in cinemas. Because of both artistic and economic reasons, the motion picture industry still applies the same procedure to transfer the film format to the video formats.

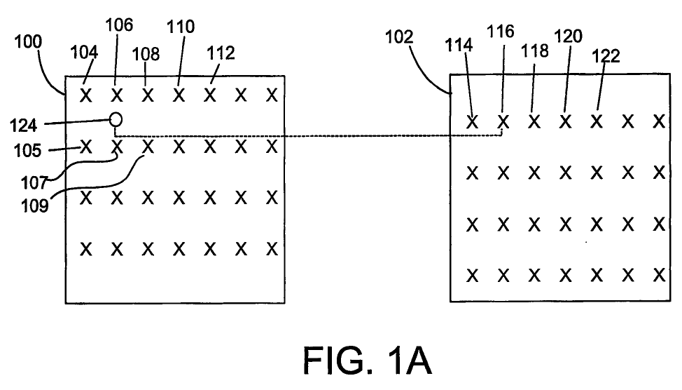

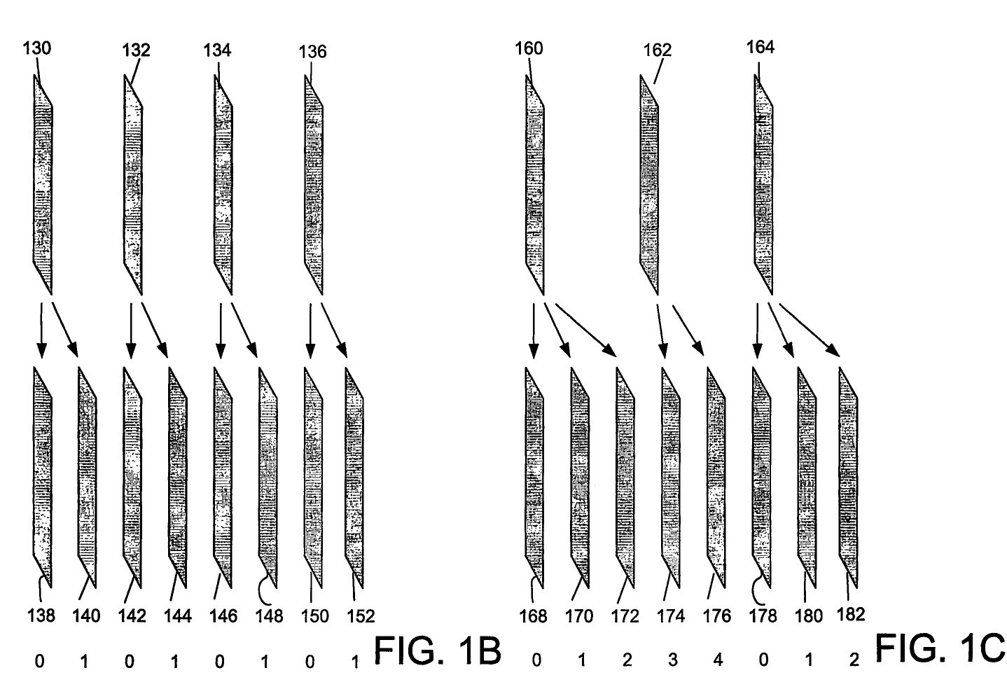

The process to transfer film to video is called the telecine process. One of the many implementations of this process is to illuminate the film and capture light coming through the film with a video camera and advancing the film in the vertical blanking period of the video signal. To change the frame rate from 24 Hz film to 50 Hz video or 60 Hz video, a process called “pull-down” is used. Pull-down is a method where the previous picture of the film is repeated until a new one is available. This method can easily be implemented mechanically. To transfer 24 Hz film to 50 Hz video, the picture rate of the film is increased to 25 pictures per second by running the film slightly faster. The four percent increase of speed and pitch of the sound is not regarded as annoying by the general public. Then, each film picture is scanned twice, creating two video fields. This method is called 2:2 pull-down. See also FIG. 1B. To transfer 24 Hz film to 60 Hz video, speed up to 30 Hz is not desired, since the speed up and the change in pitch of the sound is regarded as unacceptable by the general public. Therefore another method is used, where every even film picture is repeated three times while every odd film picture is repeated two times. This creates an increase of frame rate by a factor 2.5, resulting in a 60 Hz video signal. This method is called 3:2 pull down. See also FIG. 1C.

An image processing apparatus, like a TV, might comprise an image processing unit for computing from a series of original input images a larger series of output images. In that case, a number of the output images are temporally located between successive original input images. This computing is typically known as image rate conversion. For image rate conversion it is relevant to determine the type of the acquisition source of the received images. That means that for achieving a good image quality, it has to be detected whether the received images originate from a film camera which acquired images in a progressive scan mode at a lower image rate or originate from a video camera which acquired images at the image rate of the video signal. Based on that detection, the received video fields are combined to form images. In the case that the received video fields correspond to film then two successive fields can be merged relatively easily. In the case that the received video fields correspond to video then an interpolation of pixels values of the video fields is required which is controlled by the detected motion in the images. Incorrect handling of a video mode signal as film mode can cause severe artifacts which are clearly visible in the output images. These artifacts are known as “forks”, “mouse teeth”, “comb effect” or “zippers”. False video mode detection is less severe, but also yields artifacts.

In general, the signal as received by the image processing apparatus does not comprise an explicit indication of the type of acquisition source of the succession of the video fields. As a result, this information has to be extracted from the video fields themselves. Typically this is done by means of detecting a motion sequence pattern.

An embodiment of the motion sequence pattern detector of the kind described in the opening paragraph is known from U.S. Pat. No. 4,982,280. This patent specification discloses a motion sequence pattern detector being arranged to detect a periodic pattern of motion sequences within a succession of video fields, such as film mode or progressive scan mode. The motion sequence pattern detector comprises a motion detector for detecting the presence of motion from increment to increment within predetermined increments of the succession of video fields and for thereupon outputting a first motion detection signal for each said increment. The motion detector computes differences between pixel values of successive video fields and compares the computation results with a threshold to reduce the effect of noise. The motion sequence pattern detector further comprises logic circuitry responsive to the first motion detection signal for detecting the periodic pattern of motion sequences within the succession of video fields.

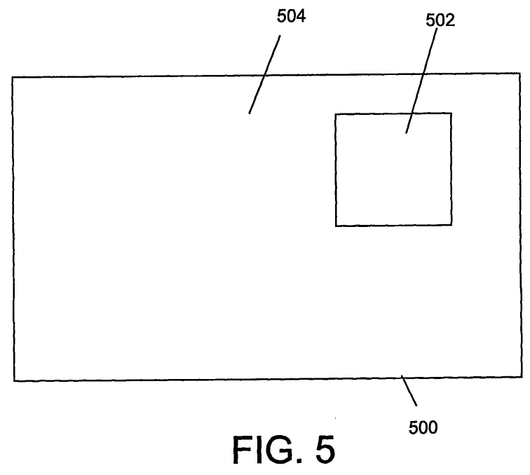

Nowadays it is fashionable to have banners, i.e. scrolling texts, and other information superimposed on video data origination from an other source. In general, these scrolling texts are in video mode. The video data upon which they are superimposed, can be in film mode. The result is a sequence of video fields that contains both objects or regions in film mode and objects in video mode (See FIG. 5). This kind of sequences are called hybrid sequences.

Besides this mixing or superimposing, some compression algorithms are arranged to encode parts of the sequence in such a manner, that 2:2 pull-down is introduced. An example of such a compression algorithms is DV (Digital Video) coding. In DV coding, parts of the image are encoded on frame basis, while other parts are encoded on field basis. This is to increase coding efficiency. Coding artifacts may cause motion patterns similar to hybrid signals.

Most available film detectors are not designed to deal with hybrid sequences, since they are arranged to classify sequences as either film mode or as video mode. E.g. for frame-rate conversion, this classification does not suffice. So, such detectors are unreliable on hybrid signals. If a hybrid sequence is detected as film mode, annoying artifacts are introduced by the frame-rate conversion in the regions that are in video mode.

In patent application US2002/0131499 a hybrid detector is disclosed. This detector works as follows. Prior to detecting a film mode, the fields of the television signal are separated into different objects by means of a segmentation technique. Any known technique to do so might be used for that purpose. Then, the film mode of each individual object is detected. Any known film mode detection technique might be used for that purpose. In this context, an “object” may be a portion of an individual image in a field. An “object” is defined as an image portion that can be described with a single motion model. Such an “object” need not necessarily comprise one “physical” object, like a picture of one person. An object may well relate to more than one physical object, e.g., a person sitting on a bike where the movement of the person and the bike, essentially, can be described with the same motion model. On the other hand, one can safely assume that objects identified in this way belong to one single image originating from one single film source.

A disadvantage of the known hybrid detector is that a separate segmentation step is required. The more so, since robust segmentation is in general relatively complex.

It is an object of the invention to provide a motion sequence pattern detector of the kind described in the opening paragraph which is arranged to deal with hybrid sequences and which is relatively simple.

This object of the invention is achieved in that the motion sequence pattern detector comprises processing means which is arranged:

to compute for a first one of the consecutive fields a value of a video motion measure and a value of a film motion measure; and

to determine the presence of film material on basis of the value of the video motion measure and the value of the film motion measure, the value of the video motion measure being computed by:

establishing a plurality of motion patterns for respective groups of pixels of the first one of the consecutive fields;

comparing each of the plurality of motion patterns with a predetermined video motion pattern and conditionally increasing the value of the video motion measure, the value of the film motion measure being computed by:

comparing each of the plurality of motion patterns with a predetermined film motion pattern and conditionally increasing the value of the film motion measure.

Instead of segmenting the field into objects with semantic meaning, a plurality of groups of pixels are created, e.g. by means of sub-sampling. The number of these groups is in the order of the number of pixels in a field, e.g. 10% or 50% of the total number of pixels in the field. Preferably the groups of pixels each have one pixel only. For each of these groups of pixels a motion pattern is established and two pattern matches are performed. The processing means is arranged to check whether the established motion pattern corresponds with a typical video pattern or whether the established motion pattern corresponds with a typical film pattern. After these checks, for the corresponding group of pixels the probable mode, i.e. film mode or video mode, for that group of pixels is known. By counting for the first one of the consecutive fields the number of times it is decided that a group of pixels has a film mode the film motion measure for that field is determined. By counting for the first one of the consecutive fields the number of times it is decided that a group of pixels has a video mode, the video motion measure for that field is determined. The eventual classification is made based on the ratio between and values of the video motion measure and the film motion measure:

the value of the film motion measure is relatively high and the value of the video motion measure is relatively low. So, the field primarily comprises material originating from a film camera, i.e. the field corresponds to film mode;

the value of the video motion measure is relatively high and the value of the film motion measure is relatively low. So, the field primarily comprises material originating from an interlaced video camera, i.e. the field corresponds to video mode;

the value of the video motion measure and the value of the film motion are comparable. So, the field comprises material originating from an interlaced video camera but also material originating from a film camera, i.e. the field corresponds to a hybrid mode.

the value of the video motion measure is relatively low and the value of the film motion measure is relatively low. No significant motion has been detected, i.e. the field corresponds to a static mode.

In an embodiment of the motion sequence pattern detector according to the invention the processing means are arranged to establish a first one of the motion patterns by computing:

a first difference between a first pixel value of the first one of the consecutive fields and a second value being derived from a second one of the consecutive fields; and

a second difference between a third pixel value of a third one of the consecutive fields and a fourth value being derived from the second one of the consecutive fields.

Hence, the motion pattern comprises two differences between values derived from subsequent fields. The computation of such a pattern is relatively easy and requires relatively little computing resource usage. Preferably the two differences are compared with thresholds to distinguish motion from noise. That means that the processing means are arranged to establish a motion pattern by comparing the first difference with a first predetermined motion threshold and the second difference with a second predetermined motion threshold.

Typically, the first predetermined motion threshold and the second predetermined motion threshold are mutually equal. Optionally, the second value and the fourth value are mutually equal. Preferably, the second value is also based on a pixel value of another fields, e.g. the first one of the consecutive fields. Preferably, the fourth value is also based on a pixel value of another field, e.g. the third one of the consecutive fields.

In an embodiment of the motion sequence pattern detector according to the invention the processing means are arranged to increase the value of the video motion measure if the first difference is larger than the first predetermined motion threshold and the second difference is larger than the second predetermined motion threshold. In the case that the motion pattern comprises two relatively high values it is assumed that the motion pattern corresponds to video mode. As a consequence the value of the video motion measure has to be increased.

In an embodiment of the motion sequence pattern detector according to the invention the processing means are arranged to modify the value of the film motion measure if only the first difference is larger than the first predetermined motion threshold or only the second difference is larger than the second predetermined motion threshold. In the case that the motion pattern comprises one relatively high value and one relatively low value it is assumed that the motion pattern corresponds to film mode. As a consequence the value of the film motion measure has to be increased.

In an embodiment of the motion sequence pattern detector according to the invention the processing means are arranged to establish a first one of the motion patterns by:

computing a third difference between the first pixel value of the first one of the consecutive fields and the third pixel value of the third one of the consecutive fields;

computing a first minimum of the first difference and the third difference and assigning the first minimum to the first difference; and

computing a second minimum of the second difference and the third difference and assigning the second minimum to the second difference. An advantage of this embodiment is that it is arranged to correctly deal with vertical detail, e.g. structures in the image which have a vertical size substantially equal to the size of one video line. These structures which are present in e.g. the odd fields and not in the even fields might be interpreted as motion. To overcome this misinterpretation the comparison with the third difference is made.

An embodiment of the motion sequence pattern detector according to the invention is arranged to output a signal indicating presence of film material at a location corresponding to a first one of the groups of pixels on basis of comparing a first one of the motion patterns, with the predetermined film motion pattern, the first one of the motion patterns corresponding to the first one of the groups of pixels. Instead of providing a classification value (film, video, hybrid or static) for the field, more detailed information is provided, e.g. a kind of mask which represents which portions of the image correspond to film mode and which portions correspond to video mode.

An embodiment of the motion sequence pattern detector according to the invention comprises a contrast measurement unit for selecting a first one of the groups of pixels by means of:

computing a first value of a contrast measure for a first set of pixels of the first one of the consecutive fields;

comparing the first value of the contrast measure with a predetermined contrast threshold; and

assigning the first set of pixels as the first one of the groups of pixel if the first value of the contrast measure is higher than the predetermined contrast threshold. By selecting pixels or groups of pixels with a relatively high amount of contrast the noise sensitivity is reduced. In other words, an advantage of this motion sequence pattern detector is that it is more robust.

In an embodiment of the motion sequence pattern detector according to the invention, the contrast measurement unit is arranged to compute the first value of the contrast measure on basis of calculating a first difference between the value of a first one of the pixels of the first set of pixels and the value of another pixel of the first one of the consecutive fields. This embodiment is arranged to compute spatial contrast.

In an embodiment of the motion sequence pattern detector according to the invention, the contrast measurement unit is arranged to compute the first value of the contrast measure on basis of calculating a second difference between the value of the first one of the pixels of the first set of pixels and the value of a further pixel of a second one of the consecutive fields. This embodiment is arranged to compute spatio-temporal contrast.

An embodiment of the motion sequence pattern detector according to the invention is arranged to compute a new predetermined contrast threshold on basis of the number of times the values of the contrast measure being computed for the first one of the consecutive fields have exceeded the predetermined contrast threshold. In other words, the value of the contrast threshold is dynamically adapted. As a consequence the number of groups of pixels which is used for the motion pattern matching is relatively constant over time. An advantage of this embodiment according to the invention is that the number of computations is relatively constant.

It is another object of the invention to provide an image processing apparatus of the kind described in the opening paragraph which comprises a motion sequence pattern detector which is arranged to deal with hybrid sequences and which is relatively simple.

This object of the invention is achieved in that the motion sequence pattern detector of the image processing apparatus, comprises processing means which is arranged:

to compute for a first one of the consecutive fields a value of a video motion measure and a value of a film motion measure; and

to determine the presence of film material on basis of the value of the video motion measure and the value of the film motion measure,

the value of the video motion measure being computed by:

establishing a plurality of motion patterns for respective groups of pixels of the first one of the consecutive fields;

comparing each of the plurality of motion patterns with a predetermined video motion pattern and conditionally increasing the value of the video motion measure, the value of the film motion measure being computed by:

comparing each of the plurality of motion patterns with a predetermined film motion pattern and conditionally increasing the value of the film motion measure.

The image processing unit of the image processing apparatus might support one or more of the following types of image processing:

Video compression, i.e. encoding or decoding, e.g. according to the MPEG standard.

De-interlacing: Interlacing is the common video broadcast procedure for transmitting the odd or even numbered image lines alternately. De-interlacing attempts to restore the full vertical resolution, i.e. make odd and even lines available simultaneously for each image;

Image rate conversion: From a series of original input images a larger series of output images is calculated. Output images are temporally located between two original input images; and

Temporal noise reduction. This can also involve spatial processing, resulting in spatial-temporal noise reduction.

The image processing apparatus optionally comprises a display device for displaying the output images. The image processing apparatus optionally comprises storage means for storage of images: either the input or the output images. The image processing apparatus might e.g. be a TV, a set top box, a VCR (Video Cassette Recorder) player, a satellite tuner, or a DVD (Digital Versatile Disk) player or recorder.

It is another object of the invention to provide a method of the kind described in the opening paragraph which can deal with hybrid sequences and which is relatively simple.

This object of the invention is achieved in that the method of detecting presence of film material in a series of consecutive video fields, comprises:

computing for a first one of the consecutive fields a value of a video motion measure and a value of a film motion measure; and

determining the presence of film material on basis of the value of the video motion measure and the value of the film motion measure, the value of the video motion measure being computed by:

establishing a plurality of motion patterns for respective groups of pixels of the first one of the consecutive fields;

comparing each of the plurality of motion patterns with a predetermined video motion pattern and conditionally increasing the value of the video motion measure, the value of the film motion measure being computed by:

comparing each of the plurality of motion patterns with a predetermined film motion pattern and conditionally increasing the value of the film motion measure.

It is another object of the invention to provide a computer program product of the kind described in the opening paragraph which can deal with hybrid sequences and which is relatively simple.

This object of the invention is achieved in that the computer program product after being loaded, providing said processing means with the capability to carry out the following steps:

computing for a first one of the consecutive fields a value of a video motion measure and a value of a film motion measure; and

determining the presence of film material on basis of the value of the video motion measure and the value of the film motion measure, the value of the video motion measure being computed by:

establishing a plurality of motion patterns for respective groups of pixels of the first one of the consecutive fields;

comparing each of the plurality of motion patterns with a predetermined video motion pattern and conditionally increasing the value of the video motion measure, the value of the film motion measure being computed by:

comparing each of the plurality of motion patterns with a predetermined film motion pattern and conditionally increasing the value of the film motion measure. Modifications of the motion sequence pattern detector and variations thereof may correspond to modifications and variations thereof of the method, of the computer program product and of the image processing apparatus described.

These and other aspects of the motion sequence pattern detector, of the method, of the computer program product and of the image processing apparatus according to the invention will become apparent from and will be elucidated with respect to the implementations and embodiments described hereinafter and with reference to the accompanying drawings, wherein:

FIG. 1A schematically shows two fields of one frame;

FIG. 1B schematically shows 2:2 pull-down;

FIG. 1C schematically shows 3:2 pull-down;

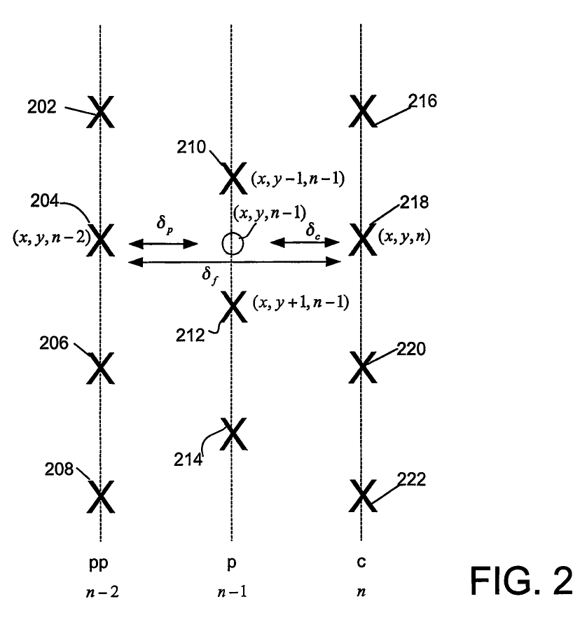

FIG. 2 schematically shows three consecutive video fields;

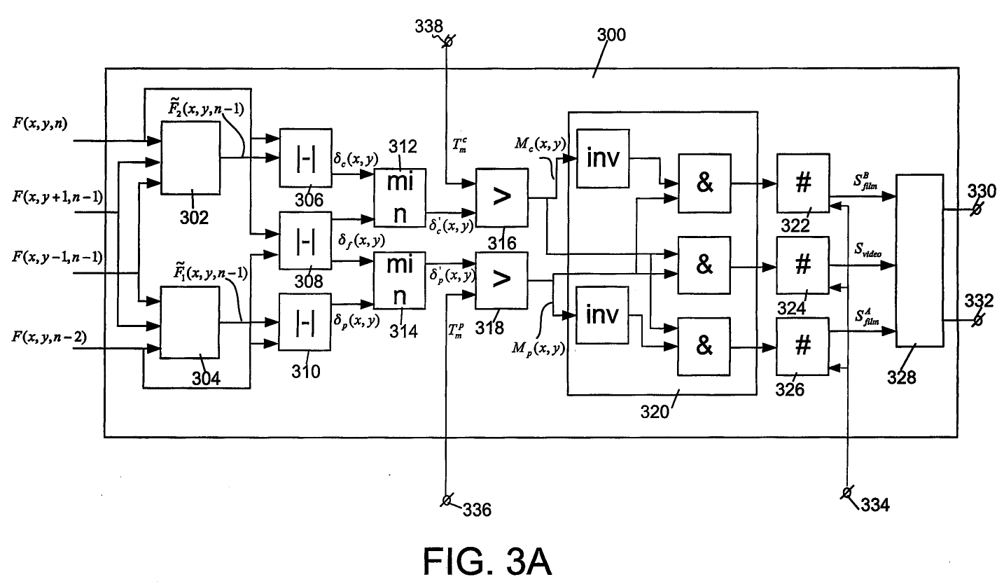

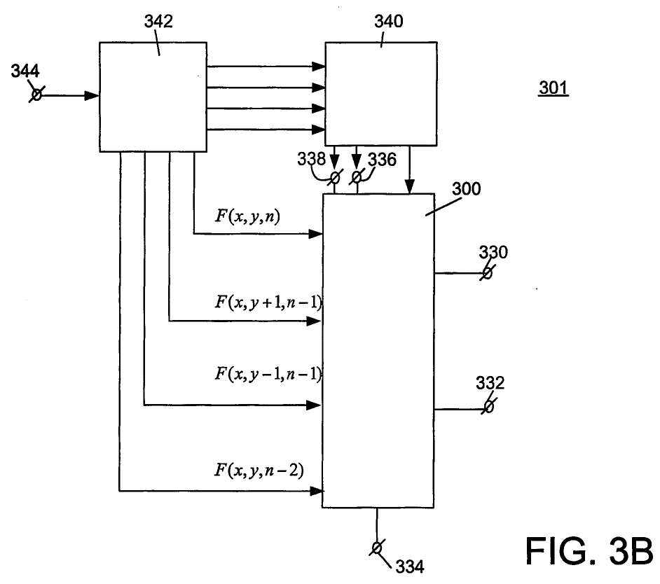

FIG. 3A schematically shows an embodiment of the motion sequence pattern detector according to the invention;

FIG. 3B schematically shows an embodiment of the motion sequence pattern detector according to the invention, comprising a contrast measurement unit;

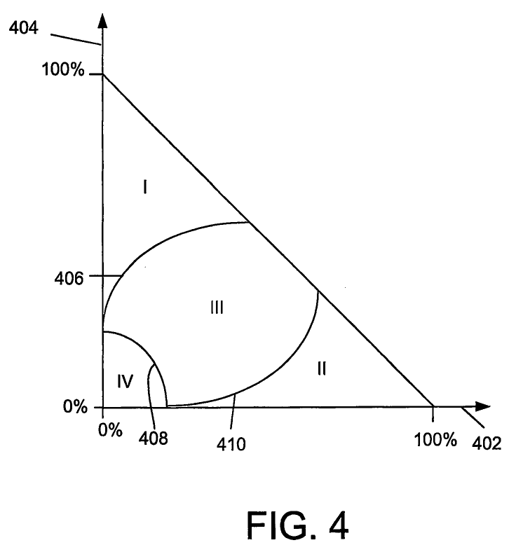

FIG. 4 schematically shows a two-dimensional feature space;

FIG. 5 schematically shows a two-dimensional mask indicating the type of mode; and

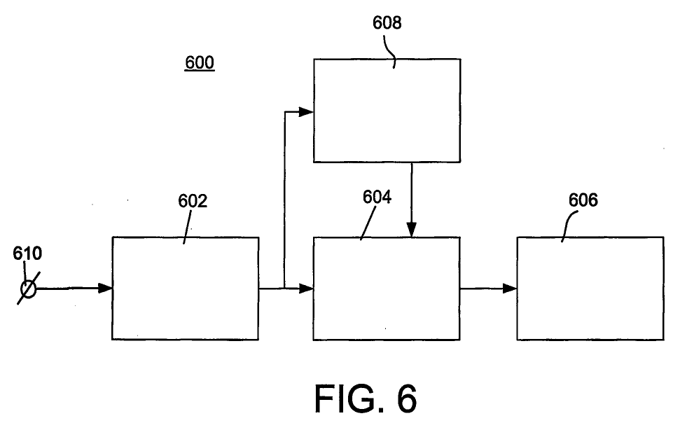

FIG. 6 schematically shows an embodiment of the image processing apparatus according to the invention.

Same reference numerals are used to denote similar parts throughout the figs.

FIG. 1A schematically shows two successive fields 100, 102 of a video signal. The first field 100 comprises the pixel values, e.g. 104-112 of the odd lines of the frame and the second field 102 comprises the pixel values, e.g. 114-122 of the even lines of the frame. For instance at frame coordinates corresponding to pixel 116 of the second field 102 there is no pixel value 124 directly available in the first field 100. That means that if a pixel value 124 is required that this pixel value has to be derived from other pixel values. For example, this pixel value is derived, i.e. can be calculated by means of an interpolation of pixel values of the first field 100, e.g. by means of an interpolation based on the pixel values 104-109. Optionally less pixel values are taken into account. An interpolation might also include an order statistical operation such as a median operation. It may also include pixels from field 102 or from a (not depicted) field preceding field 100.

FIG. 1B schematically shows 2:2 pull-down. An input stream of pictures 130-136 with a frequency of 25 Hz is up-converted to an output stream of video fields 138-152 with a frequency of 50 Hz. The different phases {0,1} of the video fields are denoted below the video fields 138-152. This film phase indicates the position in the repetition pattern and is typically calculated in a film detector.

FIG. 1C schematically shows 3:2 pull-down. An input stream of pictures 160-164 with a frequency of 24 Hz is up-converted to an output stream of video fields 168-182 with a frequency of 60 Hz. The different phases {0,1,2,3,4} of the video fields are denoted below the video fields 168-182.

FIG. 2 schematically shows a number of pixels 202-222 of three consecutive video fields: current c, previous p and pre-previous pp. The current field corresponds with n, the previous field corresponds with n−1 and the pre-previous corresponds with n−2. The current field c and the pre-previous field pp comprise even lines and the previous field p comprises odd lines. In this document, a pixel value of a pixel is denoted with a three-dimensional luminance function F(\vec{x},n), with the vector \vec{x} comprising two spatial coordinates x and y. The pixels 202-208 of the pre-previous field pp correspond to pixels of a column with a certain x-coordinate which is equal to the x-coordinate of the column to which the pixels 210-214 of the previous field p belong and equal to the x-coordinate of the column to which the pixels 216-222 of the current field c belong. For some of the pixels the coordinates are depicted. E.g. pixel 204 has coordinates (x,y,n−2) and pixel 210 has coordinates (x,y−1,n−1).

As explained in connection with FIG. 1A it is possible to determine pixel values for pixels for which there is no pixel value directly available. E.g. the value for a pixel with coordinates (x,y,n−1) might be determined by means of pixel values in the spatio-temporal environment of (x,y,n−1).

FIG. 3A schematically shows an embodiment of the motion sequence pattern detector 300 according to the invention, comprising:

a number of input connections for providing the motion sequence pattern detector 300 with luminance values of respective pixels;

a number of de-interlacing units 302 and 304;

a number of subtraction units 306-310 for calculating the absolute difference between two incoming values;

a number of minimum operators 312 and 314 for determining the minimum of two incoming values;

a number of comparators 316 and 318 for detecting whether an incoming value is higher than a predetermined threshold;

a logical unit 320 comprising a number of inverters and and-operators;

a number of counters 322-326;

a combining unit 328 for combining the results of the counters 322-326;

a number of output connectors 330 and 332;

a control interface 334 for resetting the values of the counters 322-326 after the computations for a field have been completed; and

a number of control interface 336 and 338 for adapting the values of the first predetermined motion threshold Tₘ^{p} and the second predetermined motion threshold Tₘ^{c}. The motion sequence pattern detector 300 may be implemented using one processor. Normally, these functions are performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality.

The working of the motion sequence pattern detector is as follows.

Suppose that for a particular pixel 218 with coordinates (x,y,n) the mode has to be determined. The motion sequence pattern detector 300 is provided with a number of pixel values. Alternatively the motion sequence pattern detector 300 is arranged to access a memory device 342 to retrieve these pixel values. This embodiment requires the following pixel values F(x,y,n),F(x,y,n−2), F(x,y−1,n−1) and F(x,y+1,n−1) in order to determine the mode for pixel 218 with coordinates (x,y,n). (See also FIG. 2)

On basis of three of these pixel values a first estimate \tilde{F}₁(x,y,n−1) is computed for the pixel with coordinates (x,y,n−1). This is done by the first de-interlacing unit 304. In this case the de-interlacing is based on a median operation as specified in Equation 1.
\tilde{F}₁(x,y,n−1)=Median(F(x,y−1,n−1), F(x,y+1,n−1),F(x,y,n−2)) (1)

Alternatively other types of de-interlacing can be applied, e.g. on basis of an averaging operation.

On basis of three of the input pixel values also a second estimate \tilde{F}₂(x,y,n−1) is computed for the pixel with coordinates (x,y,n−1). This is done by the second de-interlacing unit 302. In this case the de-interlacing is based on a median operation as specified in Equation 2:
\tilde{F}₂(x,y,n−1)=Median(F(x,y−1,n−1), F(x,y+1,n−1), F(x,y,n)) (2)

The next step comprises computing:

a first difference δₚ(x, y) between a first pixel value F(x,y,n−2) of the first one of the consecutive fields pp and the first estimate \tilde{F}₁(x,y,n−1) being derived from a second one of the consecutive fields p, as specified in Equation 3; and

a second difference δ_{c}(x,y) between a third pixel value F(x,y,n) of a third one of the consecutive fields c and the second estimate \tilde{F}₁(x,y,n−1) being derived from the second one of the consecutive fields p, as specified in Equation 4.
δₚ(x,y)=|F(x,y,n−2)−\tilde{F}₁(x,y,n−1)| (3)
δ_{c}(x,y)=|F(x,y,n)−\tilde{F}₂(x,y,n−1)| (4)

The next step comprises:

computing a third difference δ_{f}(x,y) between the first pixel value F(x,y,n−2) of the first one of the consecutive fields pp and the third pixel value F(x,y,n) of the third one of the consecutive fields c, as specified in Equation 5;

computing a first minimum δₚ′(x,y) of the first difference δₚ(x,y) and the third difference δ_{f}(x,y) and assigning the first minimum to the first difference, as specified in Equation 6; and

computing a second minimum δ_{c}′(x,y) of the second difference δ_{c}(x,y) and the third difference δ_{f}(x,y) and assigning the second minimum to the second difference, as specified in Equation 7.
δ_{f}(x,y)=|F(x,y,n−2)−F(x,y,n)| (5)
δₚ′(x,y)=min(δₚ(x,y), δ_{f}(x,y)) (6)
δ_{c}′(x,y)=min(δ_{c}(x,y),δ_{f}(x,y)) (7)

The next step comprises comparing the first difference δₚ′(x,y) with a first predetermined motion threshold Tₘ^{p} and the second difference δ_{c}′(x,y) with a second predetermined motion threshold Tₘ^{c}. This is done by means of comparators 318 and 316, respectively. The comparator 318 provides Boolean values Mₚ(x,y) as output, which indicate whether there is movement between the first derived pixel with coordinates (x,y,n−1) and the pixel 204 with coordinates (x,y,n−2). The comparator 316 provides Boolean values M_{c}(x,y) as output, which indicate whether there is movement between the particular pixel 218 with coordinates (x,y,n) and the second derived pixel with coordinates (x,y,n−1). The input-output relation of comparator 318 is specified in Equation 8 and the input-output relation of comparator 316 is specified in Equation 9:
If δₚ′(x,y)>Tₘ^{m} then Mₚ(x,y)=1 else Mₚ(x,y)=0 (8)
If δ_{c}′(x,y)>Tₘ^{c} then M_{c}(x,y)=1 else M_{c}(x,y)=0 (9)

Table 1 shows the four different possible combinations of the values of M_{c}(x, y) and Mₚ(x, y). These combinations correspond to possible motion patterns 1-4. For each of these patterns Table 1 indicates whether the motion pattern is a predetermined video motion pattern or one of the predetermined film motion patterns.

TABLE 1
Motion patterns

| Pattern | | | |
|---|---|---|---|
| identification | Mₚ(x, y) | M_{c}(x, y) | Type of motion pattern |
| 1 | 0 | 0 | No movement, type unknown |
| 2 | 0 | 1 | Film motion pattern, phase A |
| 3 | 1 | 0 | Film motion pattern, phase B |
| 4 | 1 | 1 | Video motion pattern |

Hence, on basis of the values of M_{c}(x,y) and Mₚ(x,y) the mode for the particular pixel 218 is determined.

The mode is determined for a large number N of pixels of each field, e.g. for 25% of the pixels of a field. The pixels might be selected on basis of a simple sub-sampling strategy. The results of the mode determinations are accumulated by means of a number of counters 322-326. Each time a pattern with identification 2 is detected then the value of S_{film}^{A} is increased with 1, as specified in Equation 10:

$${S}_{film}^{A} = {\sum }_{N} \{ 1 \vert {M}_{p} ( x , y ) = 0 ⋀ {M}_{c} ( x , y ) = 1 \} \qquad ( 10 )$$

Each time a pattern with identification 3 is detected then the value of S_{film}^{B} is increased with 1, as specified in Equation 11:

$${S}_{film}^{B} = {\sum }_{N} \{ 1 \vert {M}_{p} ( x , y ) = 1 ⋀ {M}_{c} ( x , y ) = 0 \} \qquad ( 11 )$$

Each time a pattern with identification 4 is detected then the value of S_{video} is increased with 1, as specified in Equation 12:

$${S}_{video} = {\sum }_{N} \{ 1 \vert {M}_{p} ( x , y ) = 1 ⋀ {M}_{c} ( x , y ) = 1 \} \qquad ( 12 )$$

Eventually the values S_{film}^{A}, S_{video} and S_{film}^{B}, of the counters 322-326 are combined by means of combining unit 328. One of the operations being performed by the combining unit 328 is specified in Equation 13. The reason for the subtraction of the “min”-term is to eliminate the effect of covering and uncovering. This subtraction is optionally.
S_{film}=|S_{film}^{A}−S_{film}^{B}|−min(S_{film}^{A}, S_{film}^{B}) (13)
Finally a vector S comprising two values is achieved as denoted in Equation 14:
\vec{S}=(S_{film,} S_{video}) (14)
This vector \vec{S} can be used to detect the mode using a set of thresholds as depicted in FIG. 4. The mode is provided at the output connector 330. Optionally, the vector \vec{S} is provided at the output connector 330. Optionally a two-dimensional mask indicating the type of mode per pixel or group of pixels is provided at the output connector 332. (See FIG. 5)

FIG. 3B schematically shows an embodiment of the motion sequence pattern detector 301 according to the invention, comprising a contrast measurement unit 340. The contrast measurement unit 340 is arranged to make a selection of groups of pixels on basis of the pixel values of the video fields. More particular on basis of differences between pixel values.

Suppose that each of the groups of pixels contain one respective pixel. Deciding whether a particular pixel is to be selected for the motion pattern detection, comprises the following steps:

computing the value of a contrast measure C¹(x,y,n) for the particular pixel;

comparing the value of the contrast measure C¹(x,y,n) with a predetermined contrast threshold T_{c}(n); and

assigning the particular pixel as the first one of the groups of pixel if the value of the contrast measure C¹(x,y,n) is higher than the predetermined contrast threshold T_{c}(n).

By testing a large number of pixels of a video field with coordinate n a collection B(n) of groups of pixels is created for that field. The collection B(n) is specified by means of Equation 15:
B(n)={(x,y)|∀C¹(x,y,n)>T_{c}(n)} (15)

For calculating a contrast measure C¹(x,y,n) spatial or temporal pixels, related to (x,y,n), can be applied. Optionally, multiple comparisons are made. This will be explained by means of some examples.

Suppose that the value of a first contrast measure C¹(x,y,n) is computed on basis of calculating a first difference between the value of the particular pixel and the value of another pixel of the same field, as specified if Equation 16:
C¹(x,y,n)=F(x,y,n)−F(x,y−2,n) (16)

Suppose that the value of a second contrast measure C²(x,y,n) is computed on basis of calculating a second difference between the value of the particular pixel and the value of a further pixel of the same field, as specified if Equation 17:
C²(x,y,n)=F(x,y,n)−F(x−1,y,n) (17)

Suppose that the value of a third contrast measure C³(x,y,n) is computed on basis of calculating a third difference between the value of the particular pixel and the value of a pixel of the another field, as specified if Equation 18:
C³(x,y,n)=F(x,y,n)−F(x,y,n−2) (18)

Equation 15 can be rewritten into Equation 19:
B(n)={(x,y)|∀(C¹(x,y,n)>T_{c}(n)ˆC²(x,y,n)>T_{c}(n)ˆC³(x,y,n)>T_{c}(n))} (19)

It will be clear that alternative approaches can be applied to estimate local contrast, i.e. to calculate a contrast measure C¹(x,y,n). Only those pixels which have a relatively high contrast compared to their spatio-temporal environment are selected for the motion pattern detection.

Preferably the value of the contrast threshold T_{c}(n) is dynamically adapted. E.g. if the actual selected groups of pixels for a particular field is higher than a target value, then the value of the contrast threshold T_{c}(n+1) for the next field is based on an increased value of T_{c}(n). If the actual selected groups of pixels for a particular field is lower than a target value, then the value of the contrast threshold T_{c}(n+1) for the next field is based on a decreased value of T_{c}(n). The target value might be equal to 20% of the total number of pixels of the field. As a consequence the number of groups of pixels being used per field for the motion pattern matching is relatively constant over time. An advantage of this embodiment according to the invention is that the number of computations is relatively constant.

Optionally the values of the first predetermined motion threshold Tₘ^{p} and the second predetermined motion threshold Tₘ^{c} depend on, the value of the contrast threshold T_{c}(n), e.g. as specified in Equations 20 and 21:
Tₘ^{p}(n)=0.5T_{c}(n) (20)
Tₘ^{c}(n)=0.5T_{c}(n) (21)
This means that the motion thresholds are high for fields with high contrast; so the motion sequence pattern detector becomes relatively insensitive to noise without loss of motion sensitivity. So, an advantage of this embodiment is graceful degradation, since the trade off between noise sensitivity and motion sensitivity is automatically adapted to the contrast in the video signal.

FIG. 4 schematically shows a two-dimensional feature space. The x-axis 402 corresponds with the parameter S_{film} as specified in Equation 13. The y-axis 404 corresponds with the parameter S_{video} as specified in Equation 12. Note that the two axes are normalized to the total number of pixels used to classify the motion pattern. That means that a location in the two-dimensional feature space corresponds with the vector \vec{S}=(S_{film}, S_{video}). The two-dimensional feature space is divided into a number of regions by means of a number of boundaries 406-410. Each of the regions corresponds with a certain mode. In other words, based on the computed \vec{S}=(S_{film}, S_{video}) and the rules for classification as schematically provided by means of FIG. 4 the eventual mode for a particular field can be determined:

I: The field primarily comprises material originating from an interlaced video camera and hence the field corresponds to video mode;

II: The field primarily comprises material originating from a film camera and hence the field corresponds to film mode;

III: The field comprises material originating from an interlaced video camera but also material originating from a film camera and hence the field corresponds to a hybrid mode;

IV: No significant motion has been detected and hence the field corresponds to a static mode.

FIG. 5 schematically shows a two-dimensional mask 500 indicating the types of mode of a field of a hybrid sequence. Most of the field 504 comprises material which originates from a film camera and only a relatively small portion 502 corresponds to video material. A mask as depicted in FIG. 5 is an output of the motion sequence pattern detector 300 and is provided at the output connector 332.

FIG. 6 schematically shows an embodiment of the image processing apparatus 600 according to the invention, comprising:

Receiving means 602 for receiving a signal representing input images comprising video fields. The signal may be a broadcast signal received via an antenna or cable but may also be a signal from a storage device like a VCR (Video Cassette Recorder) or Digital Versatile Disk (DVD). The signal is provided at the input connector 610;

The motion sequence pattern detector 608 as described in connection with any of the FIGS. 3A or 3B;

An image processing unit 604 for calculating a sequence of output images on basis of the succession of video fields. The image processing unit 604 is controlled by the motion sequence pattern detector 608. Control means that the output of the motion sequence pattern detector 608 influences the image processing unit 604. For instance, if the image processing unit 604 is arranged to perform de-interlacing then the output (mode and phase) is used to combine corresponding video fields to images; and

A display device 606 for displaying the output images of the image processing unit 604. This display device 606 is optional.

The image processing apparatus 600 might e.g. be a TV. Alternatively the image processing apparatus 600 does not comprise the optional display device 606 but provides the output images to an apparatus that does comprise a display device 606. Then the image processing apparatus 600 might be e.g. a set top box, a satellite-tuner, a VCR player, a DVD player or a DVD recorder. Optionally the image processing apparatus 600 comprises storage means, like a hard-disk or means for storage on removable media, e.g. optical disks. The image processing apparatus 600 might also be a system being applied by a film-studio or broadcaster.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. A motion sequence pattern detector for detecting presence of film material in a series of consecutive video fields, the motion sequence pattern detector comprising processing means which is arranged:
to compute for a first one of the consecutive fields a value of a video motion measure and a value of a film motion measure; and
to determine the presence of film material on basis of the value of the video motion measure and the value of the film motion measure,
the value of the video motion measure being computed by:
establishing a plurality of motion patterns for respective groups of pixels of the first one of the consecutive fields;
comparing each of the plurality of motion patterns with a predetermined video motion pattern and conditionally increasing the value of the video motion measure, the value of the film motion measure being computed by:
comparing each of the plurality of motion patterns with a predetermined film motion pattern and conditionally increasing the value of the film motion measure.

2. A motion sequence pattern detector as claimed in claim 1, wherein the groups of pixels each have one pixel.

3. A motion sequence pattern detector as claimed in claim 1, wherein the processing means are arranged to establish a first one of the motion patterns by computing:
a first difference between a first pixel value of the first one of the consecutive fields and a second value being derived from a second one of the consecutive fields; and
a second difference between a third pixel value of a third one of the consecutive fields and a fourth value being derived from the second one of the consecutive fields.

4. A motion sequence pattern detector as claimed in claim 3, wherein the processing means are arranged to establish the first one of the motion patterns by comparing the first difference with a first predetermined motion threshold and the second difference with a second predetermined motion threshold.

5. A motion sequence pattern detector as claimed in claim 4, wherein the processing means are arranged to establish a first one of the motion patterns by:
computing a third difference between the first pixel value of the first one of the consecutive fields and the third pixel value of the third one of the consecutive fields;
computing a first minimum of the first difference and the third difference and assigning the first minimum to the first difference; and
computing a second minimum of the second difference and the third difference and assigning the second minimum to the second difference.

6. A motion sequence pattern detector as claimed in claim 4, wherein the processing means are arranged to increase the value of the video motion measure if the first difference is larger than the first predetermined motion threshold and the second difference is larger than the second predetermined motion threshold.

7. A motion sequence pattern detector as claimed in claim 4, wherein the processing means are arranged to modify the value of the film motion measure if only the first difference is larger than the first predetermined motion threshold or only the second difference is larger than the second predetermined motion threshold.

8. A motion sequence pattern detector as claimed in claim 1, being arranged to output a signal indicating presence of film material at a location corresponding to a first one of the groups of pixels on basis of comparing a first one of the motion patterns, with the predetermined film motion pattern, the first one of the motion patterns corresponding to the first one of the groups of pixels.

9. A motion sequence pattern detector as claimed in claim 1, comprising a contrast measurement unit for selecting a first one of the groups of pixels by means of:
computing a first value of a contrast measure for a first set of pixels of the first one of the consecutive fields;
comparing the first value of the contrast measure with a predetermined contrast threshold; and
assigning the first set of pixels as the first one of the groups of pixel if the first value of the contrast measure is higher than the predetermined contrast threshold.

10. A motion sequence pattern detector as claimed in claim 9, wherein the contrast measurement unit is arranged to compute the first value of the contrast measure on basis of calculating a first difference between the value of a first one of the pixels of the first set of pixels and the value of another pixel of the first one of the consecutive fields.

11. A motion sequence pattern detector as claimed in claim 10, wherein the contrast measurement unit is arranged to compute the first value of the contrast measure on basis of calculating a second difference between the value of the first one of the pixels of the first set of pixels and the value of a further pixel of a second one of the consecutive fields.

12. A motion sequence pattern detector as claimed in claim 9, which is arranged to compute a new predetermined contrast threshold on basis of the number of times the values of the contrast measure being computed for the first one of the consecutive fields have exceeded the predetermined contrast threshold.

13. An image processing apparatus, comprising:
receiving means for receiving a signal corresponding to a series of consecutive video fields ;
a motion sequence pattern detector as claimed in claim 1; and
an image processing unit for computing a sequence of output images on basis of the series of consecutive video fields the image processing unit being controlled by the motion sequence pattern detector.

14. An image processing apparatus as claimed in claim 13, characterized in further comprising a display device for displaying the output images.

15. An image processing apparatus as claimed in claim 14, characterized in that it is a TV.

16. An image processing apparatus as claimed in claim 13, characterized in further comprising storage means for storage of the output images.

17. An image processing apparatus as claimed in claim 16, characterized in that it is a DVD recorder.

18. A method of detecting presence of film material in a series of consecutive video fields, comprising:
computing for a first one of the consecutive fields a value of a video motion measure and a value of a film motion measure; and
determining the presence of film material on basis of the value of the video motion measure and the value of the film motion measure,
the value of the video motion measure being computed by:
establishing a plurality of motion patterns for respective groups of pixels of the first one of the consecutive fields;
comparing each of the plurality of motion patterns with a predetermined video motion pattern and conditionally increasing the value of the video motion measure, the value of the film motion measure being computed by:
comparing each of the plurality of motion patterns with a predetermined film motion pattern and conditionally increasing the value of the film motion measure.

19. A computer program product to be loaded by a computer arrangement, comprising instructions to detect presence of film material in a series of consecutive video fields, the arrangement comprising processing means and a memory, the computer program product, after being loaded, providing said processing means with the capability to carry out the following steps:
computing for a first one of the consecutive fields a value of a video motion measure and a value of a film motion measure; and
determining the presence of film material on basis of the value of the video motion measure and the value of the film motion measure,
the value of the video motion measure being computed by:
establishing a plurality of motion patterns for respective groups of pixels of the first one of the consecutive fields;
comparing each of the plurality of motion patterns with a predetermined video motion pattern and conditionally increasing the value of the video motion measure, the value of the film motion measure being computed by:
comparing each of the plurality of motion patterns with a predetermined film motion pattern and conditionally increasing the value of the film motion measure.
